(19) United States
(12) Patent Application Publication
(10) Pub. No.: US 2015/0086775 A1
(43) Pub. Date: Mar. 26, 2015

(54) SOY-BASED ADHESIVES WITH IMPROVED LOWER VISCOSITY

(71) Applicant: SOLENIS TECHNOLOGIES, L.P., Schaffhausen (CH)

(72) Inventors: Anthony J. Allen, Madison, WI (US); Bryan K. Spraul, Wilmington, DE (US)

(21) Appl. No.: 14/491,319

(22) Filed: Sep. 19, 2014

Related U.S. Application Data
(60) Provisional application No. 61/880,474, filed on Sep. 20, 2013.

(51) Int. Cl. C09D 189/00

(52) U.S. Cl. CPC C09D 189/00
USPC 428/326; 523/449; 427/207.1

(57) ABSTRACT

The technology is directed towards soy-based adhesive compositions having improved viscosity properties due to the use of soy flour having a particular particle size distribution. These compositions are useful for making lignocellulosic composites or engineered wood products.

This application claims the benefit of U.S. Patent Application No. 61/880,474, Filed 20 Sep. 2013, the entire contents of which are hereby incorporated by reference.

### FIELD OF THE INVENTION

The invention is directed towards soy-based adhesive compositions having improved viscosity properties due to the use of soy flour having a particular particle size distribution. These compositions are useful for making lignocellulosic composites or engineered wood products.

### BACKGROUND OF THE INVENTION

Adhesives derived from protein-containing soy flour first came into general use during the 1920's (U.S. Pat. Nos. 1,813,387, 1,724,695 and 1,994,050). Soy flour suitable for use in adhesives is obtained by removing some or most of the oil from the soybean, yielding a residual soy meal that is subsequently ground into fine soy flour.

More recently, amine-epichlorohydrin polymers (AE polymers) have been used in combination with proteins as adhesives for wood products (U.S. Pat. Nos. 7,060,798, 7,252,735 and 8,147,968); U.S. Patent Applications 2008/0050602 and 2008/0292886). AE/soy combinations have been used as adhesives for plywood in commercial systems showing improved adhesive performance than traditional soy-based compositions under both dry and wet conditions.

Though soy-based adhesives formulated in an aqueous medium provide many desirable attributes, there are certain properties of these materials that can be improved. One of the challenges of soy-based adhesive systems is to develop formulations with manageable viscosity. A lower viscosity formulation allows the adhesive to be sprayed and/or to be used at higher solids levels when making engineered wood products such as particleboard (PB), oriented strand board (OSB), chip board, flake board, high density fiberboard (HDF) and medium density fiberboard (MDF). Approaches for reducing the viscosity of soy-based adhesive compositions have been disclosed in the patent literature (U.S. Patent Applications 2008/0050602 and 2010/0093896) but there is still a need for soy-based adhesive systems having lower viscosity and/or higher solids levels with manageable viscosity. U.S. Patent applications 2010/0129640 and 2012/0149813 disclose an aqueous binder composition used in a flexible substrate material wherein one of the components is a soy flour having a particle size of no greater than 43 microns (μm) (325 mesh). A process for producing soy flour having an average particle size of less than 100 microns is disclosed in U.S. Patent application 2007/0212472.

Another area where viscosity can play a role is in the pH adjustment of the adhesive composition. Experience has shown that higher pH values, particularly in the basic region of 7 to 12, will provide improved tack and bond quality. For example, adhesives with higher pH values have been shown to work well to adhere difficult to bond wood types such as fir or pine. However, the viscosity of soy-based adhesive formulations increase dramatically as the pH is increased. It is often quite difficult to prepare an adhesive formulation having an alkaline pH that has reasonable pot life and/or viscosity stability. A soy-based adhesive with a pH in the alkaline region having high solids and good viscosity stability would be a very useful material.

Our studies have shown that an adhesive composition using soy flour having a particular particle size distribution wherein 70% of the particles have an average particle size of 30 μm and less, provides for a substantial decrease in viscosity compared to typical commercially available adhesive materials.

### BRIEF SUMMARY OF THE INVENTION

It has been discovered that the use of soy flour having a particle size distribution wherein at least 70% of the particles have a particles size of 30 microns (μm) or less gives low viscosity adhesive compositions. Adhesive formulations prepared using soy flour having a particle size of less than 30 microns (μm) showed a significant decrease in viscosity compared to control samples.

The decrease in viscosity that is seen using the claimed composition can be leveraged in a number of ways or in a combination of ways when making composite structures such as engineered wood products. Low viscosity, higher solids sprayable adhesive formulations of the claimed composition can be used in the manufacture of composite structures such as, particleboard, waferboard and oriented strandboard. Lower viscosity formulations are also advantageous for coating applications with equipment such as curtain coaters or extrusion coaters. The lowered viscosity allows the application of higher solids aqueous-based formulations than would be achievable with conventional soy flour compositions being used in the manufacture of composite structures today. Having a lower viscosity also allows the adhesive compositions to have higher pH while maintaining pot life and viscosity stability. Formulations with pH values in the alkaline range can provide for adhesives having improved tack, dry adhesive strength and wet adhesive properties in plywood and other engineered wood products.

A composite structure is used herein to mean a combination of two or more materials, each of which contributes to the properties of the resultant material. As used herein, an engineered wood product includes a range of derivative materials which are manufactured by binding strands, particles, flakes, chips, fibers or veneers of wood together with an adhesive to form a composite material. A composite structure as used herein is the combination of two or more substrate materials bonded together by an adhesive.

### DETAILED DESCRIPTION OF THE DRAWINGS

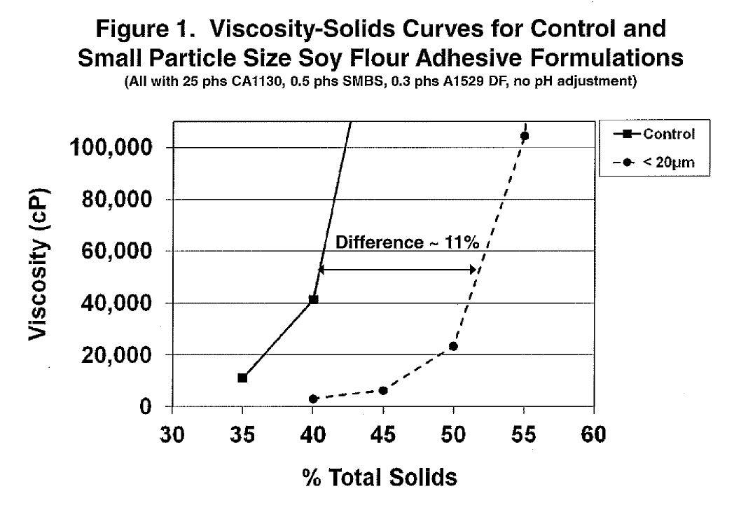

FIG. 1 shows a comparison of the viscosity-solids relationship for a control soy flour sample and the reduced particle size soy flour sample D of Example 1.

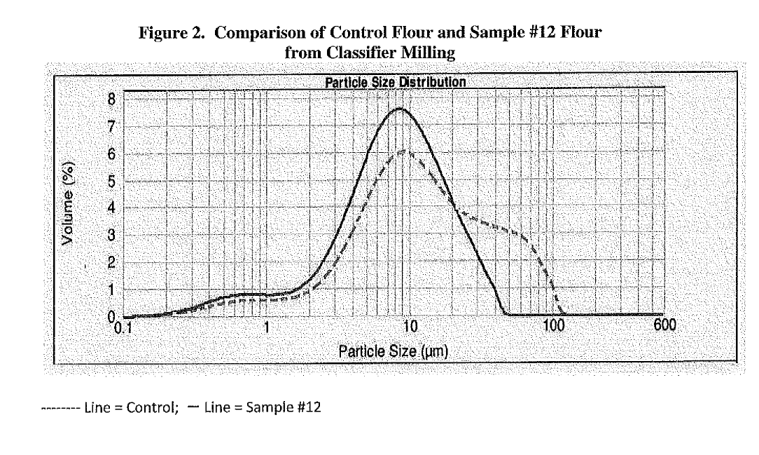

FIG. 2 depicts the particle size distribution of control soy flour and a reduced particle size soy flour sample.

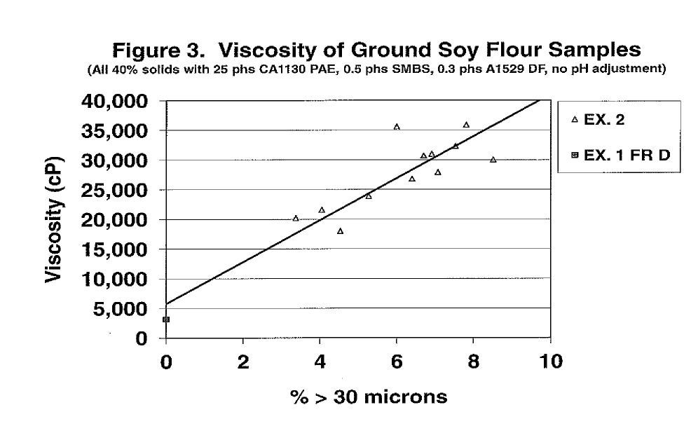

FIG. 3 is a plot of adhesive formulation viscosity as a function of the soy flour particle size percentage that falls above 30 micron particle.

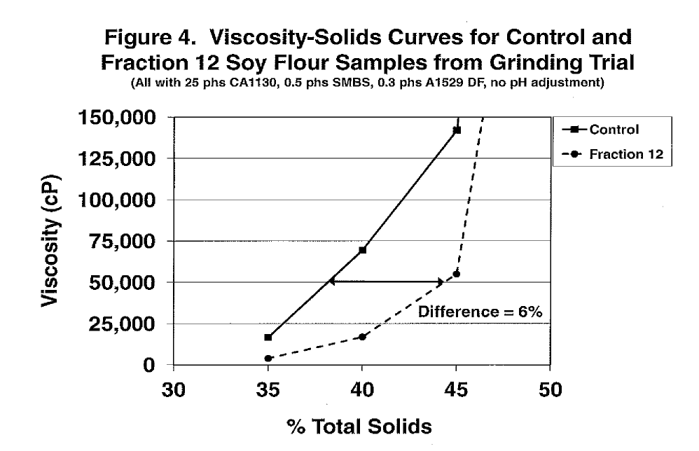

FIG. 4 is a plot of the viscosity-solids relationship for a control soy flour sample and the reduced particle size soy flour sample #12 of Example 2.

### DETAILED DESCRIPTION OF THE INVENTION

Protein-based adhesives are well known in the art. Suitable proteins for use in the present invention include casein, blood meal, feather meal, keratin, gelatin, collagen, gluten, wheat gluten (wheat protein), whey protein, zein (corn protein), rapeseed meal, sunflower meal and soy protein.

Soy is a particularly useful source of protein for the current invention. Soy can be used in the form of soy protein isolates, soy flour, soy meal or toasted soy. Soy flour suitable for use in adhesives can be obtained by removing some or most of the oil from the soybean, yielding a residual soy meal that is subsequently ground into fine soy flour. Typically, hexane is used to extract the majority of the non-polar oils from the crushed soybeans, although extrusion/extraction methods are also suitable means of oil removal. Residual hexane in the extracted soy flakes is typically removed by one of two processes: a desolventiser toaster (DT) process or by using a flash desolventiser system (FDS). The use of the DT process results in a more severe heat treatment of the soy (maximum temperature of about 120° C.; 45-70 minutes residence time) than the FDS process (maximum temperature of about 70° C.; 1-60 seconds residence time). The DT process results in a darker product typically referred to as soy meal or toasted soy. These terms will be used interchangeably to refer to soy products processed by the DT method.

The ability of the protein portion of the soy product to be dissolved or dispersed in water is measured by a Protein Dispersibility Index (PDI) test. This test has been described as follows: “For this test, a sample of soybeans is ground, mixed in a specific ratio with water, and blended at a set speed (7,500 rpm) for a specific time (10 minutes). The nitrogen contents of the ground soybeans and of the extract are determined using the combustion method. The PDI value is the quotient of the nitrogen content of the extract divided by the nitrogen content of the original bean.” Illinois Crop Improvement Association Inc. website: http://www.ilcrop.com/ipglab/soybtest/soybdesc.htm, accessed on Jul. 27, 2008.

The protein portion of DT-processed soy products has a lower solubility/dispersibility in water than the soy products processed by the IDS method as indicated by lower PDI values. Soy meals (toasted soy), typically have PDI values of 20 or less, whereas the FDS-processed soy products have PDI values ranging from 20 to 90.

The soy flour can be further purified (usually by solvent extraction of soluble carbohydrates) to give soy protein concentrate which contains about 65 wt. % protein on dry basis. Defatted soy can also be purified to produce soy protein isolate (SPI), which has a protein content of at least about 85 wt. % on dry basis.

The protein may be pretreated or modified to improve its solubility, dispersibility and/or reactivity. The soy protein may be used as produced or may be further modified to provide performance enhancements. U.S. Pat. No. 7,060,798, the entire content of which is herein incorporated by reference, teaches methods of modifying protein and their incorporation in to an adhesive composition. It is contemplated that modified protein and/or modified soy flour can be used with the present invention.

Soy protein is commonly obtained in the form of soy flour (about 52 wt. % protein, dry basis) by grinding defatted soy flakes to pass through a 100 mesh (149 μm) or 200 mesh (74 μm) screen. It has been discovered that further reducing the particle size, and in particular, by removing or further comminuting the portion of the soy flour with particle size greater than 30 μm will provide a substantial decrease in the viscosity of adhesive formulations made with the soy flour.

The particles greater than 30 μm can be removed by sieving or air classification or other mechanical separation processes. They can be further reduced in size by comminuting with a grinding mill, a classifier mill, a ball mill or any other type of mechanical equipment designed to produce powdered materials having a particle size distribution wherein 70% of the particles have an average particle size of 30 μm or less.

An optional component of the present invention is a reactive thermosetting resin, typically an amine-epichlorohydrin (AE) resin. Polyamidoamine-epichlorohydrin polymers (PAE polymers) are one subset of the AE polymers. The PAE polymers are characterized by the presence of reactive azetidinium functionality and amide functionality in the backbone. These thermosetting materials rely on the azetidinium functionality as the reactive cross-linking moiety [H. H. Espy “Alkaline-Curing Polymeric Atnine-Epichlorohydrin Resins” in Wet Strength Resins and Their Application, L. Chan, Ed., pp. 13-44, TAPPI Press, Atlanta Ga. (1994)]. Particularly useful PAE resins are Hercules CA1400, Hercules CA1920, Hercules CA1920A, Hercules CA1100 and Hercules CA1130, all available from Hercules Incorporated, Wilmington, Del. AE polymers are well-known in the art, mainly for use as wet-strengthening agents for paper products (U.S. Pat. Nos. 2,926,116, 2,926,154, 4,287,110, 4,336,835, 4,501,862, 4,537,657, 5,017,642, 5,171,795, 5,256,727, 5,364,927, 5,470,742, 5,575,892, 5,714, 552, 5,614,597, 6,222,006, 6,908,983 and 7,175,740). AE polymers are produced as aqueous solutions with solids contents ranging from about 10% to about 50%.

Another embodiment of the invention is the use of small particle size soy flour, i.e. having a particle distribution wherein 70% of the particles are 30 micron or less, in the preparation of soy dispersions such as a urea-denatured soy dispersions as described in U. S. Patent Application No. 2008/0021187, which is incorporated herein in its entirety. The use of a viscosity modifier can provide lower viscosity in these compositions and allows the preparation of stable dispersions with higher solids values than could be achieved without the use of a viscosity modifier.

Adhesives based on the combination of AE polymers and proteins are a recent development. U.S. Pat. No. 7,252,735 discloses the use of PAE polymers and soy protein with a ratio of protein to PAE polymer ranging from 1:1 to about 1000:1, more particularly from about 1:1 to about 100:1, based on dry weight. These adhesives provide greatly improved adhesive properties under wet conditions compared to adhesives based on soy protein alone. Another beneficial feature of these adhesives is that they have no added formaldehyde, and thus do not contribute to formaldehyde emissions in wood products made with them.

The adhesive compositions of the invention can also include various additives that are included in the formulation to impart specific attributes such as defoaming additives, acids, bases and buffers for pH control, surfactants, viscosity modifiers and adhesion promoters.

Another embodiment of the invention is the application of these compositions to the surface of a substrate material in making composite structures, such as, for making lignocellulosic composites, engineered wood products and other synthetic or inorganic composite materials. The compositions can be applied to a substrate surface by a variety of methods such as roller coating, knife coating, extrusion, curtain coating, foam coaters and spray coaters, one example of which is the spinning disk resin applicator. Although requirements vary for different grades and types of applications, lower viscosity is beneficial especially when using these application techniques, and in particular when used for spraying of adhesive formulations.

In addition to lignocellulosic substrates, the adhesive compositions can be used with other engineered substrates such as glass wool, glass fiber and other inorganic materials. The adhesive compositions can also be used with combinations of lignocellulosic and inorganic substrates. The above cited references are hereby incorporated in their entirety.

### Examples

### Example 1

A sample of Prolia 200/90 defatted soy flour (available from Cargill Inc., Minneapolis Minn.) was used for these experiments. The manufacturer's specification for this product states that at least 95% of the particles will pass through a 200 mesh (74 μm) screen. This material was fractionated using screens having mesh sizes of 200 (74 μm), 400 (37 μm) and 635 (20 μm). This operation gave four separate fractions of the flour having defined particle sizes. These results are summarized in Table 1.

TABLE 1
Sieve Fractionation of Soyad TS9200 Flour

| | | Particle | Amount Sieved | |
|---|---|---|---|---|
| Fraction | Mesh Size | Size | Mass | % |
| A | >200 mesh | >74 μm | 9.29 | 8.5% |
| B | <200 and >400 mesh | 37-74 μm | 19.11 | 17.5% |
| C | <400 and >635 mesh | 20-37 μm | 11.85 | 10.9% |
| D | <635 mesh | <20 μm | 68.71 | 63.1% |

The above flour fractions were used to prepare water-based adhesive formulations in combination with a polyamidoamine-epichlorohydrin (PAE) curing agent, sodium metabisulfite viscosity modifier and an added defoamer (Advantage 1529 defoamer). The adhesive formulation is shown in Table 2. This formulation has a total solids content of 40%.

TABLE 2
Adhesive Formulation

| Adhesive | | | | |
|---|---|---|---|---|
| Formulation | | PHS | % | Grams |
| Ingredient | Solids (%) | (Dry Soy Basis) | (WB) | Added |
| TS9200 Soy Flour | 95% | 100.00 | 34.16% | 49.53 |
| CA1100 PAE Resin | 20% | 23.80 | 38.61% | 55.99 |
| A-1529 Defoamer | 100% | 0.20 | 0.06% | 0.09 |
| Sodium metabisulfite | 100% | 0.20 | 0.06% | 0.09 |
| Water | 0% | | 27.10% | 39.30 |

The adhesive formulations were prepared by first adding water, defoamer and PAE resin to the mixing vessel and stirring with a mechanical stirrer for one minute. Half of the soy flour was then added with vigorous mixing. At this point the sodium metabisulfite was added while stirring followed by the rest of the soy flour. This mixture was then stirred at 1,000 rpm for 5 minutes. No pH adjustment was made to the formulations.

Table 3, provides a listing of the composition and properties of the adhesive formulations made in this manner. The first sample listed is a control sample (112-69) made using un-fractionated soy flour (control). The next four adhesive samples listed (112-107, 112-111, 112-115 and 112-119) were prepared by replacing a portion of the control soy flour with 10% of the four cuts obtained from the fractionation process (A, B, C and D, respectively) described above. The final sample listed (112-123) was made using 100% of fraction D.

TABLE 3
Adhesive Formulations Made With Fractionated Flour

| | | | | | | RV |
|---|---|---|---|---|---|---|
| | | Fraction | % | | | Viscosity |
| NB | Fraction | Size | Added | Density | | Centipoise |
| # | Added | (μm) | Fraction | (g/mL) | pH | (cP) (1) |
| 112-69 | Control | — | 100 | 1.03 | 5.39 | 55,600 |
| 112-107 | A | >74 | 10 | 0.99 | 5.30 | 59,800 |
| 112-111 | B | 37-74 | 10 | 1.01 | 5.29 | 65,400 |
| 112-115 | C | 20-37 | 10 | 1.03 | 5.29 | 63,000 |
| 112-119 | D | <20 | 10 | 1.04 | 5.31 | 40,800 |
| 112-123 | D | <20 | 100 | 1.09 | 5.39 | 8,000 |

(1) Viscosity was measured with an RV viscometer using a #6 spindle @ 10 rpm at 23° C.

When 10% of the control flour was replaced with the larger sized fractions A, B and C, the viscosity of the formulations increased by 8% to 18%. Surprisingly, when 10% of the control flour was replaced with Fraction D (<20 μm) the viscosity dropped by about 25%. When the sample of 100% Fraction D was used for this adhesive formulation the viscosity decreased to only 8,000 cP. This drop in viscosity of almost an order of magnitude is quite significant in providing a broader operating window for preparing soy-based adhesive formulations.

A series of wood adhesive formulations having varied solids contents were prepared to quantify the effect of solids on viscosity of the test flour and also a sample of control flour. Results are shown in Table 4.

TABLE 4
Viscosity at Varied Solids Levels

| | Soy | | RV | | | |
|---|---|---|---|---|---|---|
| Notebook | Flour | Total | Viscosity | Spindle/ | Density | |
| Number | Type | Solids | (cP) | RPM | (g/mL) | pH |
| 117-103 | <20 μm | 40 | 3,160 | 6/10 | 1.052 | 5.29 |
| 117-105 | <20 μm | 45 | 6,360 | 6/10 | 1.087 | 5.28 |
| 117-107 | <20 μm | 50 | 23,400 | 6/10 | 1.069 | 5.28 |
| 117-109 | <20 μm | 55 | 104,400 | 6/10 | 1.087 | 5.29 |
| 117-111 | <20 μm | 60 | >400,000 | — | — | — |
| 117-95 | TS9200 | 35 | 11,200 | 6/10 | 0.976 | 5.17 |
| 117-97 | TS9200 | 40 | 41,400 | 6/10 | 0.830 | 5.13 |
| 117-99 | TS9200 | 45 | 172,800 | 6/10 | 0.748 | 5.19 |
| 117-101 | TS9200 | 50 | >400,000 | | | |

All formulations with 25 phs CA1130 PAE, 0.5 phs SMBS and 0.3 phs A1529 DF
Viscosity was measured with an RV viscometer using a #6 spindle @ 10 rpm at 23° C.

A plot of the results listed in Table 4 can be seen in FIG. 1. When one compares the solids content for the control flour and Fraction D flour formulations at a viscosity value of 50,000 cP it is seen that using Fraction D flour allows one to increase the solids content by 11% while maintaining the same viscosity value of 50,000 cP.

### Example 2

A soy flour grinding/separation trial was performed to produce a large quantity of small particle size flour. This trial was performed using a classifier mill available from Prater-Sterling, Bolingbrook Ill. With this type of mill the larger particles are recycled to the grinder to be ground further. The particle size distributions of the trial samples were measured using a Malvern particle size analyzer. Analysis of a control sample showed that about 22% of the particles above 30 microns. Several different settings for the classifier mill were varied yielding 11 samples of about two to three pounds each having from 3.4% to 8.5% of the particles above 30 microns. The final settings yielded flour having about 3.4% of the particles greater than 30 microns. A large quantity of flour (88#) was milled using these settings.

The process conditions used and the properties of the various samples generated in the grinding trial are shown in Table 5. Most of these were from runs that generated 2-3 pounds of sample. The volume weighted mean particle size and percent of the sample with particle size greater than 30 μm are shown for these samples. The classifier speed and static pressure correlated with smaller particle size values and lower values of the fraction of particles greater than 30 microns. The amount of material with a particle size greater than 30 μm for Sample #12 had been lowered to 3.4% from a value of 22.1% for the control, a reduction of 84%. The volume weighted mean particle size decreased by half, going from 20.2 μm for the control to 10.1 μm for Sample 12.

TABLE 5
Soy Flour Grinding Trial Samples

| Run Number: | Control | 1 | 2 | 3 | 4 | 5 | 6 |
|---|---|---|---|---|---|---|---|
| Mill Tip Speed (M/S) | — | 118 | 118 | 123 | 123 | 123 | 123 |
| Classifier Speed (RPM) | — | 2,026 | 2,316 | 2,605 | 3,185 | 2,026 | 2,605 |
| Number of Jaws | — | 6 | 6 | 6 | 6 | 6 | 6 |
| Screen Size (mm) | — | 0.5 | 0.5 | 0.5 | 0.5 | 0.3 | 0.3 |
| Screen Type | — | Tri | Tri | Tri | Tri | Tri | Tri |
| Screen Open Area (%) | — | 8.0 | 8.0 | 8.0 | 8.0 | 6.4 | 6.4 |
| Total Air (CFM) | — | 820 | 820 | 820 | 820 | 820 | 820 |
| Static Pressure (″ WC) | — | 15.1 | 16.2 | 16.6 | 19.7 | 16.5 | 17.5 |
| Mill No Load (Amps) | — | 15.0 | 15.1 | 15.4 | 15.3 | 14.2 | 14.3 |
| Mill Run Load (Amps) | — | 18.1 | 16.1 | 16.8 | 16.8 | 14.8 | 15.1 |
| Classifier No Load (Amps) | — | 1.7 | 1.7 | 1.7 | 1.7 | 1.4 | 1.5 |
| Classifier Run Load (Amps) | — | 1.7 | 1.8 | 1.8 | 1.9 | 1.5 | 1.5 |
| Mill Horespower Used in Run: | — | 13.9 | 12.4 | 12.9 | 12.9 | 11.4 | 11.6 |
| Feed Amount (#) | — | 12.5 | 5 | 5 | 5 | 5 | 5 |
| Feed Rate (#/hr) | — | 250 | 100 | 100 | 100 | 100 | 100 |
| Capacity (#/hr/hp) | — | 18 | 8.1 | 7.7 | 7.7 | 8.8 | 8.6 |
| Total Sample Mass (#) | — | 6.94 | 2.88 | 2.83 | 2.70 | 2.91 | 3.12 |
| Volume Weighted Mean (μ) | 20.2 | 12.9 | 12.2 | 12.0 | 10.6 | 11.4 | 11.8 |
| % > 30μ | 22.1 | 8.5 | 7.5 | 6.4 | 4.0 | 6.0 | 6.7 |

| Run Number: | 7 | 8 | 9 | 10 | 11 | 12 |
|---|---|---|---|---|---|---|
| Mill Tip Speed (M/S) | 123 | 123 | 123 | 123 | 123 | 123 |
| Classifier Speed (RPM) | 2,316 | 2,316 | 2,896 | 3,475 | 3,822 | 3,822 |
| Number of Jaws | 6 | 6 | 6 | 6 | 6 | 6 |
| Screen Size (mm) | 0.3 | 0.3 | 0.3 | 0.3 | 0.3 | 0.3 |
| Screen Type | Tri | Tri | Tri | Tri | Tri | Tri |
| Screen Open Area (%) | 6.4 | 6.4 | 6.4 | 6.4 | 6.4 | 6.4 |
| Total Air (CFM) | 820 | 749 | 749 | 749 | 749 | 749 |
| Static Pressure (″ WC) | 15.3 | 12.2 | 15.1 | 16.3 | 23.8 | 23.7 |
| Mill No Load (Amps) | 14.2 | 14.2 | 14.3 | 14.3 | 14.2 | 14.2 |
| Mill Run Load (Amps) | 14.9 | 15.0 | 15.0 | 15.2 | 15.0 | 17.8 |
| Classifier No Load (Amps) | 1.4 | 1.5 | 1.5 | 1.7 | 1.7 | 1.7 |
| Classifier Run Load (Amps) | 1.5 | 1.5 | 1.8 | 1.7 | 1.7 | 1.8 |
| Mill Horespower Used in Run: | 11.5 | 11.5 | 11.5 | 11.7 | 11.5 | 13.7 |
| Feed Amount (#) | 5 | 5 | 5 | 5 | 5 | 75 |
| Feed Rate (#/hr) | 100 | 100 | 100 | 100 | 100 | 75 |
| Capacity (#/hr/hp) | 8.7 | 8.7 | 8.7 | 8.6 | 8.7 | 5.5 |
| Total Sample Mass (#) | 2.37 | 2.39 | 2.61 | 2.98 | 3.06 | 88.11 |
| Volume Weighted Mean (μ) | 11.9 | 12.5 | 11.8 | 10.6 | 10.8 | 10.1 |
| % > 30μ | 6.9 | 7.8 | 7.1 | 4.5 | 5.3 | 3.4 |

FIG. 2 shows a comparison of the particle size distribution of the control flour and the Sample #12 soy flour. The large particle size material has been converted to smaller sized particles as evidenced by the reduction of the shoulder ranging from about 20 to 100 microns in the particle size distribution plot of the control sample.

Adhesive formulations with 40% solids were prepared using the 12 samples generated in Example 2 from the classifier mill trial and the control flour. These results are shown in Table 6. A plot of these viscosity values as a function of the percentage of particles greater than 30 μm is shown in FIG. 3. The viscosity is seen to be directly proportional to the level of particles above 30 microns. We also included the viscosity results for the sample of soy flour that was sieve fractionated to remove all of the material with particle size greater than 30 microns. This point fits well with the line for the Prater-Sterling trial samples.

TABLE 6
Adhesive Formulations Made with Ground Soy Flour Samples

| | | RV | | | | | |
|---|---|---|---|---|---|---|---|
| Notebook | | Viscosity | Spindle/ | Density | % > | Temp | |
| Number | Fraction | (cP) | RPM | (g/mL) | 30μ | (° C.) | pH |
| 122-109 | 1 | 30,000 | 6/10 | 0.915 | 8.5 | 30.8 | 5.16 |
| 122-111 | 2 | 32,300 | 6/10 | 0.907 | 7.5 | 27.8 | 5.16 |
| 122-125 | 3 | 26,800 | 6/10 | 0.944 | 6.4 | 26.1 | 5.27 |
| 122-127 | 4 | 21,600 | 6/10 | 0.926 | 4.0 | 27.3 | 5.29 |
| 122-129 | 5 | 35,600 | 6/10 | 0.885 | 6.0 | 28.1 | 5.31 |
| 122-131 | 6 | 30,700 | 6/10 | 0.896 | 6.7 | 29.6 | 5.28 |
| 122-133 | 7 | 31,000 | 6/10 | 0.828 | 6.9 | 28.9 | 5.28 |
| 122-135 | 8 | 35,900 | 6/10 | 0.920 | 7.8 | 28.1 | 5.28 |
| 122-137 | 9 | 27,900 | 6/10 | 0.920 | 7.1 | 27.2 | 5.29 |
| 122-139 | 10 | 18,000 | 6/10 | 0.947 | 4.5 | 27.3 | 5.34 |
| 122-141 | 11 | 23,900 | 6/10 | 0.917 | 5.3 | 26.6 | 5.33 |
| 122-143 | 12 | 20,200 | 6/10 | 0.937 | 3.4 | 25.6 | 5.36 |
| 122-107 | Control | 36,500 | 6/10 | 0.907 | 22.1 | 27.9 | 5.14 |

All formulas 40% TS with 25 phs CA1130, 0.5 phs SMBS and 0.3 phs A1529 DF
Viscosity was measured with an RV viscometer using a #6 spindle @ 10 rpm at 23° C.

These results demonstrate that the amount of large particles in the soy flour is the controlling factor for the viscosity of our adhesive formulations. These results also indicate that the viscosity change is not due to any change in chemical composition, since the large particles were recycled in the grinding operation and no material was removed.

A series of wood adhesive formulations having varied total solids contents was prepared using a control flour and ground flour (sample #12). Results are shown in Table 7. Sample #12 formulations are all lower in viscosity than the control samples.

TABLE 7
Viscosity of Formulations with Varied Solids Contents

| | Soy | | RV | | | |
|---|---|---|---|---|---|---|
| Notebook | Flour | Total | Viscosity | Spindle/ | Density | |
| Number | Type | Solids | (cP) | RPM | (g/mL) | pH |
| 124-25 | EX. 2: #12 | 35 | 3,880 | 5/10 | 1.004 | 5.43 |
| 124-29 | EX. 2: #12 | 40 | 16,900 | 6/10 | 0.922 | 5.46 |
| 124-33 | EX. 2: #12 | 45 | 55,000 | 6/10 | 0.946 | 5.34 |
| 124-39 | Control | 35 | 16,600 | 6/10 | 0.951 | 5.46 |
| 124-41 | Control | 40 | 69,400 | 6/10 | 0.835 | 5.43 |
| 124-43 | Control | 45 | 142,000 | 7/10 | 0.836 | 5.38 |

All formulations with 25 phs CA1130 PAE, 0.5 phs SMBS and 0.3 phs A1529 DF
Viscosity was measured with an RV viscometer at 23° C. using the spindle and RPM combination shown.

The solids-viscosity data shown in Table 7 are plotted in FIG. 4. It can be seen that by using the ground soy flour (sample #12) of Example 2 compared to the control soy flour one can increase the solids by about 6% while maintaining the viscosity at 50,000 cP.

### Example 3

Adhesive formulations were prepared to provide a comparison of Cargill Prolia 200/90 soy flour (Cargill Inc., Minneapolis Minn.) and Honeysoy F90 (CHS Inc, Inver Grove Heights, Minn.). The Prolia 200/90 flour had an average particle size of 24μ with 27.9% of the particles larger than 30 μm as analyzed with a Sympatec Helos particle size analyzer. The Honeysoy F90 flour was specified to have a granulation such that 95% of the flour would pass through a 325 mesh screen. This sample had an average particle size of 16 μm with 9.6% of the particles larger than 30 μm as analyzed with a Sympatec Helos particle size analyzer. Lower (40.2%) and higher (44.7%) solids formulations were prepared to provide a comparison of adhesive formulations having equivalent viscosity with the two types of flour. The Prolia 200/90 flour in the 40.2% solids formulation gave a similar viscosity to the Honeysoy F90 sample in the 40.2% solids formulation. A 44.7% solids formulation was also prepared using the Prolia 200/90 soy flour to compare and contrast with the Honeysoy F90 flour. 40.2% Solids Formulation: In a 600 mL stainless steel beaker water (120.4 g), CA1130 PAE resin (77.0 g) and soy flour (51.05 g) were mixed until the flour was fully dispersed (3 minutes). Sodium metabisulfite (0.51 g) was then added to the mixture followed by additional 51.05 g soy flour. The resulting mixture was stirred for an additional 8 minutes at 1,000 rpm. 44.7% Solids Formulation: A 44.7% solids formulation was prepared in the same manner as described above using the following quantities of starting materials: Water 100.3 g; CA1130 PAE resin 85.6 g; Soy flour two portions of 56.75 g; and sodium metabisulfite 0.57 g. The viscosity of these formulations was measured using a Brookfield RV viscometer with a #6 spindle at 10 rpm and at a temperature of 23° C. The pH of these formulations was measured with a calibrated pH meter. Cargill Prolia 200/90 flour was used to prepare adhesive formulations at both the low solids (40.2%; Example 3-A) and the high solids (44.7%; Example 3-B). The Honeysoy F90 flour was used to make a high solids (44.7%) formulation (Example 3-C).

These adhesive formulations were used to prepare laboratory scale panels of engineered wood flooring (EWF). The EWF panels were 5-ply panels that had red oak face and back veneers that were 1.94 mm thick and yellow poplar core veneers that were 2.16 mm thick. The veneers were stored in a controlled atmosphere room at 70° F. with a relative humidity of 30% for at least one week prior to panel preparation. The panels were prepared using an adhesive spread rate of 44 to 48 pounds per thousand square feet using a lay-up time (open assembly time) of 3.5 to 4.5 minutes, a stand time (closed assembly time) of 15 minutes, a cold press step for 5 minutes at 100 psi and a hot press step of 4 minutes at 125 psi and 250° F. During the panel preparation the tack of the panels was evaluated qualitatively out of the cold press. The panels were scored on a scale of 0 to 5 where 0 corresponded to very poor tack and panel consolidation and a score of 5 indicated excellent tack and panel consolidation.

The panels were tested for 3-cycle soak performance using the ANSI/HPVA HP-1-2009-4.6 procedure. The 3-cycle soak testing was performed using 3 test pieces per condition. In addition to the ANSI/HPVA pass/fail criteria for the 3-cycle soak test, the samples were also evaluated using a quantitative delamination, or delamination scale. This scale ranges from 0, indicating that the bond line had no delamination at all to 10 which corresponds to a completely delaminated bond line. The ANST/HPVA failure point on this scale is 6 and above (greater than 2″ delamination). The scoring criteria for the delamination scale are shown in Table 8.

TABLE 8
Numerical Delamination Scoring Criteria for 3-Cycle Soak Testing

| Grade | Pass/Fail | Dry (Required) |
|---|---|---|
| 0 | Pass | No delamination at all in bond line |
| 1 | Pass | Minimal delamination, <0.1″ |
| 2 | Pass | Minimal delamination, <0.25″ |
| 3 | Pass | Moderate delamination, <0.5″ |
| 4 | Pass | Moderate delamination, <1″ |
| 5 | Pass | Major delamination, <2″ |
| 6 | Fail | Major delamination, 2-3″ |
| 7 | Fail | Severe delamination, 3-4″ |
| 8 | Fail | Very severe delamination, 4-5″ |
| 9 | Fail | Near complete veneer separation |
| 10 | Fail | Complete Veneer separation |

The wet shear adhesive bond strength was measured using the EN 314 class 1 test procedure. Wet shear values are the average of 8 test samples. Properties of the formulations and the panels made with them are shown in Table 9.

TABLE 9
Panel Preparation and Testing - Example 3

| | | | | | | | Panel Testing | | | | |
|---|---|---|---|---|---|---|---|---|---|---|---|
| | | | | | | Panel Prep | 3-Cycle Soak | | 24 Hr. Soak Shear Test | | |
| Adhesive Formulations | | | | | | BL1/BL2 | | Avg. | Wet | Wet | Wet |
| Example | Notebook | % | Soy | | Visc. | BL3/BL4 | % | Delam | Shear | SD | % |
| Number | Number | Solids | Flour | pH | (cP) | Tack | Pass | Score | (psi) | (psi) | WF |
| 3-A | AMR 4-41-1 | 40.2% | Prolia 200/90 | 5.22 | 42,000 | 1/5/5/1 | 100% | 0.42 | 137 | 9 | 12 |
| 3-B | AMR 4-43-1 | 44.7% | Prolia 200/90 | 5.20 | 84,800 | 3/5/5/4 | 100% | 0.50 | 177 | 25 | 16 |
| 3-C | AMR 4-45-1 | 44.7% | Honeysoy F90 | 5.19 | 48,110 | 3/5/5/4 | 100% | 0.33 | 224 | 25 | 8 |

Viscosity was measured with an RV viscometer using a #6 spindle @ 10 rpm at 23° C.

In general, the panels made with higher solids adhesive formulations gave better properties. This was true for the Honeysoy F90 formulation even though the viscosity was about equal to the viscosity of the low solids Prolia 200/90 formulation. The panels made with the formulations having higher solids levels showed an improvement in tack for the face and back veneers (BL1 and BL4). All of the panels passed the 3-cycle soak at 100% and gave very low delamination scores. The higher solids formulations showed much better wet shear strength than the lower solids formulation.

These results show that the adhesive formulations made with soy flour having a smaller fraction of particles above 30 μm provide equivalent or improved adhesive properties than adhesive formulations made with soy flour having a larger fraction of particles above 30 p.m. This holds true whether the adhesive formulations have a similar viscosity or whether the viscosity of the larger particle size formulation is greater.

### Example 4

(X35399-23-2, X35399-25-2, X35399-27) Soy dispersions were made using Cargill Prolia 200/90 as described above and Honeysoy F90 (CHS Inc, Inver Grove Heights, Minn.), which had a particle size of 95% less than 325 mesh. In a 1 liter (L) beaker of water (193.06 g), Advantage 357 defoamer (0.48 g), sodium metabisulfite (1.44 g), glycerol (60.53 g), and soy flour (137.32 g) were mixed until the flour was fully dispersed. Sulfuric acid 98% (10.04 g) was then added and the dispersion mixed for 30 minutes at which time water (41.63 g) and urea (47.37 g) was added and the dispersion mixed for 30 minutes. Sodium tetraborate decahydrate (58.37 g) was then added and the solution mixed for an additional 10 minutes. The viscosity of the final dispersion was measuring using a LV Brookfield viscometer with a #4 spindle at 10 rpm and 23° C.

Particleboard samples were then made with the soy dispersion from Example 3. The adhesive for the particleboard consisted of 166.92 g of the soy dispersion and 31.89 g of a PAE resin, Soyad CL4180, (Ashland Inc, Ashland, Ky.) blended together. A portion of the adhesive (82.24 g) was distributed onto core particleboard wood furnish (545 g) using an air atomizing spray head. The treated wood furnish (608.38 g) was then placed in a 10″ forming box and pre-pressed at 100 psi. The particleboard mat was then hot pressed to ½″ thickness for 180 seconds at thickness. Each condition was run in duplicate.

The resulting particleboard panels were then cut into 1″×8″ strips that were tested for peak bending strength using a 3 point bend test. These test results are summarized in Table 8. The soy dispersion made with the smaller particle size Honeysoy F90 flour was lower in viscosity (2,250 cP) than the control soy dispersion made with Cargill Prolia 200/90 soy flour (8,300 cP). The bending strength of the particleboard samples made with the small particle size soy flour was equivalent to that seen with the larger particle size soy flour control sample.

TABLE 8
Viscosity and Strength of Samples Made
with Different Particle Size Flours

| | Soy Dispersion | Peak Bending | Bend Strength |
|---|---|---|---|
| Soy Flour | Viscosity (cP) | Strength (psi) | SD (psi) |
| Cargill Prolia 200/90 | 8,300 | 2,038 | 76 |
| | | 1,969 | 188 |
| Honeysoy F90 | 2,250 | 2,079 | 167 |
| | | 2,107 | 112 |

We claim:

1. An aqueous thermosetting binder composition comprising soy flour slurry and optionally a reactive thermosetting resin; wherein at least 70% of the particles of the soy flour have a particle size of less than about 30 microns.

2. The binder composition according to claim 1, wherein the optional reactive thermosetting resin is a polyamidoamine-epichlorohydrin (PAE) resin.

3. The composition of claim 1, wherein the binder composition further comprises additional additives selected from the group consisting of defoaming aids, acids, bases, buffers, surfactants, viscosity modifiers and adhesion promoters.

4. The composition of claim 2, wherein the ratio of PAE resin to soy flour is from about 1 parts per hundred to about 75 parts per hundred dry soy flour.

5. The composition of claim 2, wherein the ratio of PAE resin to soy flour is from about 5 parts per hundred to about 50 parts per hundred dry soy flour.

6. The composition of claim 2, wherein the ratio of PAE resin to soy flour is from about 8 parts per hundred to about 40 parts per hundred dry soy flour.

7. A process of producing an aqueous adhesive binder comprising:
obtaining soy flour slurry, wherein at least 70% of the particles have a particle size of less than about 30 microns; and combining the slurry with at least one reactive thermosetting resin.

8. The process according to claim 7, wherein the reactive thermosetting resin is polyamidoamine-epichlorohydrin (PAE).

9. The process of claim 8, wherein the ratio of PAE resin to soy flour is from about 1 parts per hundred to about 75 parts per hundred dry soy flour.

10. The process of claim 8, wherein the ratio of PAE resin to soy flour is from about 5 parts per hundred to about 50 parts per hundred dry soy flour.

11. The process of claim 8, wherein the ratio of PAE resin to soy flour is from about 8 parts per hundred to about 40 parts per hundred dry soy flour.

12. A method of making a composite structure comprising applying the aqueous adhesive binder according to claim 1, to at least one surface of a lignocellulosic substrate or synthetic substrate; and forming a composite structure.

13. The composite structure of claim 12, wherein the composite structure is made from lignocellulosic substrates.

14. The process according to claim 10, wherein the binder composition is applied by roller coating, knife coating, extrusion, curtain coating, foam coaters and spray coaters.
